(19) United States
(12) Patent Application Publication
(10) Pub. No.: US 2011/0217971 A1
(43) Pub. Date: Sep. 8, 2011

(54) METHOD AND SYSTEM FOR PERFORMING RETRANSMISSION REQUEST THROUGH BASE STATION COOPERATION IN COMMUNICATION SYSTEM

(76) Inventors: Yu Seok Kim, Seoul (KR); Eun Yong Kim, Gyeonggi-do (KR); Tak Ki Yu, Gyeonggi-do (KR); Sang Min Lee, Seoul (KR)

(21) Appl. No.: 13/128,330

(22) PCT Filed: Nov. 24, 2009
(86) PCT No.: PCT/KR09/06943

§ 371 Date: May 9, 2011

(30) Foreign Application Priority Data
Nov. 27, 2008 (KR) 10-2008-0118853

(51) Int. Cl. H04W 4/18

(52) U.S. Cl. 455/422.1

(57) ABSTRACT

A method and system is disclosed that requests a retransmission through base station cooperation in a communication system. The method for performing a retransmission request includes: receiving data from a main base station; transmitting a retransmission request of the received data; and receiving the data from the main base station in response to the retransmission request. A sub base station performing cooperation communication with the main base station receives the retransmission request from the mobile station and changes the format of transmission with respect to mobile stations communicating with the sub base station. The method and system can allow only a small amount of information to be exchanged among base stations in a base station cooperation system, thereby effectively reducing inter-cell interference and increasing the probability of successfully receiving retransmitted data.

### TECHNICAL FIELD

The present invention relates to communication systems, and more particularly, to a method and system that requests a retransmission through base station cooperation in a communication system, and thus reduces inter-cell interference of a portable terminal that receives a re-transmission signal.

### BACKGROUND ART

Communication systems provide multimedia services as well as voice services. In recent years, they have been implemented with multiple input multiple output (MIMO) systems in order to provide high quality multimedia services at a high rate. Such communication systems increase a channel capacity with a limited frequency resource by using a plurality of antennas, so that they can provide high speed multimedia services.

The communication system is composed of a plurality of cells adjacent to each other. In each cell, there is a base station to control the cell. The base station allows for the connection of a plurality of mobile stations. In a single cell, communication for a multimedia service can be performed between the base station and the mobile station. The convention communication system is disadvantageous in that inter-cell interference occurs at the boundary area between cells. This is because the mobile station may receive a plurality of signals, in the boundary area between cells, from a plurality of base stations. In that case, a signal for another mobile station may interfere with communication of one mobile station. There are many conventional techniques used to suppress inter-cell interference. For example, a decentralized method can perform a suppressing operation so that signals related to other base stations do not interfere with a mobile station linked to a particular base station. That is, the decentralized method restricts or recommends the use of a pre-coding matrix index, which may cause interference with a mobile station in a base station, in another base station, thereby suppressing inter-cell interference in the communication system.

### DISCLOSURE OF INVENTION

### Technical Problem

The pre-coding matrix index restriction technique or pre-coding matrix index technique serves to effectively reduce inter-cell interference of mobile station located at the boundary area between cells. However, conventional techniques have not established a method for reducing inter-cell interference when retransmission is performed. This method may be considered by extending a retransmission technique in a single cell. However, this retransmission technique in a single cell does not allow for the special situation of a base station cooperation system and thus it is necessary to further reduce inter-cell interference in retransmission.

### Solution to Problem

The present invention has been made in view of the above problems, and provides a method and system that can allow a relatively small amount of information to be exchanged among base stations in a base station cooperation system and thus reduce inter-cell interference.

In accordance with an exemplary embodiment of the present invention, the present invention provides a method for performing a retransmission request in a mobile station in a base station cooperation system, including: receiving data from a main base station; transmitting a retransmission request of the received data; and receiving the data from the main base station in response to the retransmission request. A sub base station performing cooperation communication with the main base station receives the retransmission request from the mobile station and changes the format of transmission with respect to mobile stations communicating with the sub base station.

In accordance with another exemplary embodiment of the present invention, the present invention provides a mobile station that requests retransmission in a base station cooperation system, comprising a controller for receiving data from a main base station, transmitting a retransmission request of the received data, and receiving the data from the main base station in response to the retransmission request. A sub base station performing cooperation communication with the main base station receives the retransmission request from the mobile station and changes the format of transmission with respect to mobile stations communicating with the sub base station.

In accordance with another exemplary embodiment of the present invention, the present invention provides a method for transmitting data in a sub base station performing cooperation communication with a main base station in a base station cooperation system, including: receiving a retransmission request for data from the main base station; changing, if the retransmission request is received, the format of transmission with respect to mobile stations within a coverage of the sub base station; and transmitting the data to the mobile station according to the changed format of transmission.

In accordance with another exemplary embodiment of the present invention, the present invention provides a base station system where a sub base station performs cooperation communication with a main base station in a base station cooperation system and performs transmission of data. The base station system includes a controller for receiving a retransmission request for data transmitted from the main base station, changing the format of transmission with respect to mobile stations within a coverage of the sub base station, and transmitting the data to the mobile station according to the changed format of transmission.

### Advantageous Effects of Invention

As described above, the method and system for performing retransmission in a pre-coding matrix index based base station cooperation system, according to the present invention, can allow only a small amount of information to be exchanged among base stations in a base station cooperation system, thereby effectively reducing inter-cell interference and increasing the probability of successfully receiving retransmitted data.

### BRIEF DESCRIPTION OF DRAWINGS

The features and advantages of the present invention will become more apparent from the following detailed description in conjunction with the accompanying drawings, in which:

FIG. 1 is a view illustrating a configuration of a communication system based on a pre-coding matrix index through base station cooperation, according to an embodiment of the present invention;

FIG. 2 is a view illustrating a configuration of a base station cooperation system for performing re-transmission according to a first embodiment of the present invention;

FIG. 3 is a signal flow chart that describes a method for performing retransmission in a base station cooperation system according to a first embodiment of the present invention;

FIG. 4 is a view illustrating a configuration of a base station cooperation system for performing retransmission according to a second embodiment of the present invention;

FIG. 5 is a view illustrating a concept of a method for performing retransmission in a base station cooperation system according to a second embodiment of the present invention;

FIG. 6 is a signal flow chart that describes a method for performing retransmission in a base station cooperation system according to a second embodiment of the present invention;

FIG. 7 is a view illustrating a configuration of a base station cooperation system for performing retransmission according to a third embodiment of the present invention; and

FIG. 8 is a signal flow chart that describes a method for performing retransmission in a base station cooperation system according to a third embodiment of the present invention.

### MODE FOR THE INVENTION

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

Although the drawings represent an embodiment of the invention, the drawings are not necessarily to scale and certain features may be exaggerated or omitted in order to better illustrate and explain the present invention. The same reference numbers are used throughout the drawings to refer to the same or similar parts.

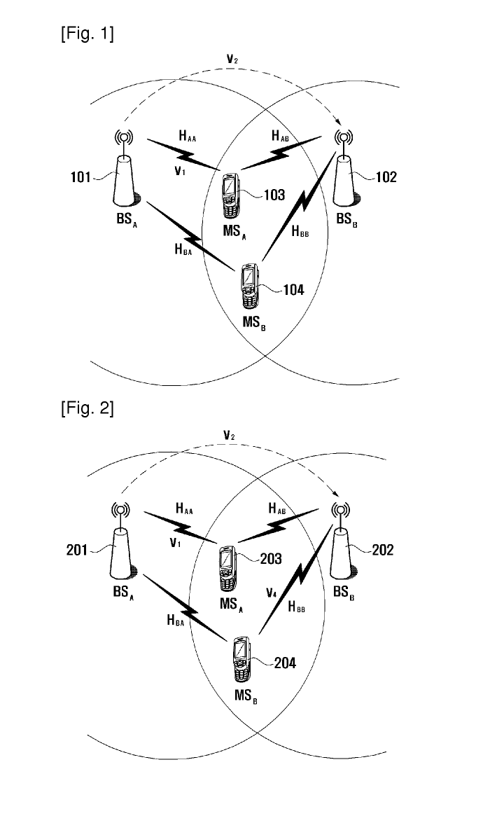

FIG. 1 is a view illustrating a configuration of a communication system based on a pre-coding matrix index through base station cooperation, according to an embodiment of the present invention.

Referring to FIG. 1, a pre-coding matrix index restriction technique and a pre-coding matrix index recommendation technique are explained. In the communication system shown in FIG. 1, there are two adjacent cells one of which includes a base station BS_{A} 101 and a mobile station MS_{A 1}03 and another of which includes a base station BS_{B} 102 and a mobile station MS_{B} 104.

The base station and the mobile station share a code book serving as a set of pre-coding matrixes. For example, it is assumed that the base station and the mobile station share a code book composed of M pre-coding matrixes as described in the following equation (1). The base station uses the pre-coding matrixes to process downlink information via beamforming.

VA,VBε{V1,V2,V3, . . . ,VM} (1)

MS_{A 103} and MS_{B} 104 are located in the boundary area between the cells. Therefore, a signal that the BS_{B} 102 transmits to the MS_{B} 104 will arrive at the MS_{A} 103, with a relatively high intensity. In particular, if the two mobile stations are using the same time-frequency resources, the signal may cause interference with the base station MS_{A} 103. This restricts the performance of the MS_{A} 103 located in the boundary area between the cells. The MS_{A} 103 and MS_{B} 104 receive signals described as the following equations (2) and (3).

y_{A}=H_{AA}v_{A}s_{A}+H_{AB}v_{B}s_{B}+n_{A} (2)

y_{B}=H_{BA}v_{A}s_{A}+H_{B}BᵥBs_{B}+n_{B} (3)

Where H_{AA} denotes a channel of the MS_{A} 103 and BS_{A} 101, and H_{BB} denotes a channel of the MS_{B} 104 and BS_{B} 102. H_{AB} and H_{BA} are channels through which an interference signal is transmitted. s_{A} and s_{B} denote data that is transmitted to the MSA 103 and MSB 104, respectively. n_{A} and n_{B} refer to noise.

As described in equations (2) and (3), H_{AB}v_{B}s_{B} and H_{BA}v_{A}s_{A} show channels that interfere with the mobile stations and restrict the reception performance. A pre-coding matrix index restriction or recommendation technique is employed to reduce the interference.

In a pre-coding matrix index restriction technique, a base station is distinguished between a main base station BS_{A} that requests pre-coding matrix index restriction and a sub-base station BAS_{B} that follows the request of the main base station BS_{A}. MS_{A} 103 estimates a downlink channel between BS_{B} 102 and itself, and then acquires one of the pre-coding matrix indexes that the BS_{B} 102 can use, where the acquired pre-coding matrix index v₂ will be estimated to affect the greatest interference to the MS_{A} 103. When the pre-coding matrix index v₂ is feedback to the BS_{A} 101, the BS_{A} 101 transmits the information regarding the pre-coding matrix index v₂ to the BS_{B} 102. The BS_{B} 102 does not use the pre-coding matrix index v₂ that is restricted by the MS_{A} 103, based on the received information, when the BSB 102 transmits data to the MS_{B} 104. Although the MS_{A} 103 may suffer from interference when the BS_{B} 102 uses other precoding matrix index, its performance can be maintained throughout.

In a pre-coding matrix index recommendation technique, the MS_{A} 103 requests to use only a predetermined pre-coding matrix index from the BS_{B} 102. On the contrary, in the pre-coding matrix index restriction technique, the MS_{A} 103 requests not to use a particular pre-coding matrix index v₂ from the BS_{B} 102. In terms of interference reduction, the pre-coding matrix index recommendation technique is more effective than the pre-coding matrix index restriction technique. However, in the pre-coding matrix index recommendation technique, the BS_{B} 102 doe not provide large scale transmission to the MS_{B} 104.

FIG. 2 is a view illustrating a configuration of a base station cooperation system for performing re-transmission according to a first embodiment of the present invention.

Referring to FIG. 2, a base station is distinguished between a main base station BS_{A} 201 that requests to change a pre-coding matrix index and a sub-base station BS_{B} 202 that follows the request of the main base station BS_{A} 201. When a retransmission request NACK is generated during the communication between the BS_{A} 201 and a MS_{A} 203, the MSA 203 may transmit the retransmission request NACK to a BS_{B} 202 directly or via the BS_{A} 201, so that the BS_{B} 202 allows for selecting a pre-coding matrix index v₃ and other pre-coding matrix index v₄ from a code book when a pre-coding matrix index of the MS_{B} 204 is initially transmitted. Therefore, although a pre-coding matrix index may be selected that causes a performance reduction between the BS_{B} 202 and the MS_{B} 204, compared with the pre-coding matrix index selected at the initial transmission, the retransmission between the BS_{A} 201 and the MS_{A} 202 can be successfully performed.

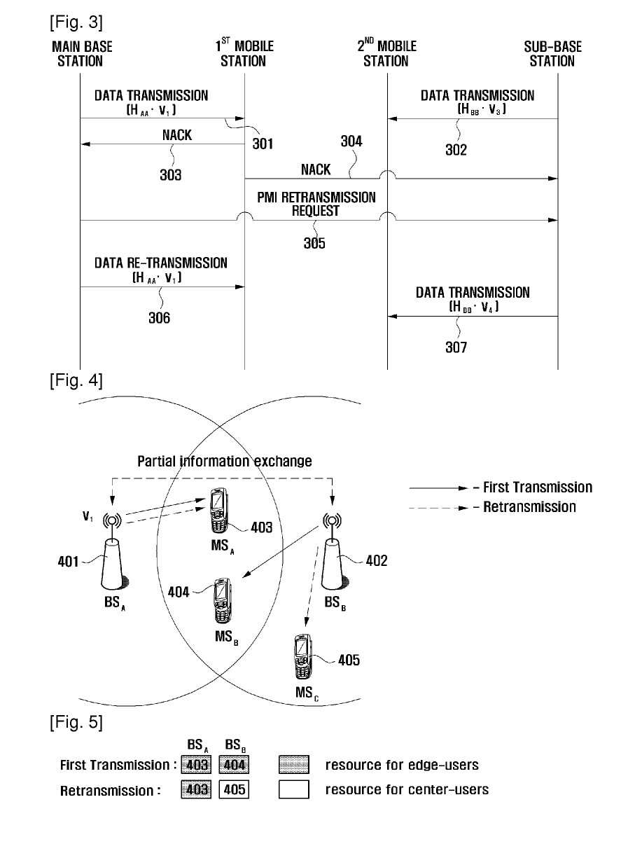

FIG. 3 is a signal flow chart that describes a method for performing retransmission in a base station cooperation system according to a first embodiment of the present invention.

Referring to FIG. 3, the main base station transmits data to the first mobile station via a channel H_{AA} (301). In an embodiment of the present invention, it is assumed that transmission is performed using a pre-coding matrix index v₁, and the sub base station is restricted to using a pre-coding matrix index v₂ by the pre-coding matrix index restriction technique.

The sub base station transmits data to the second mobile station via a channel H_{BB} at the time the main base station performs the data transmission (302). At 302, the sub base station performs the data transmission using a pre-coding matrix index v₃. When the first mobile station recognizes its received signal as an interference signal, interfering with a signal transmitted from the sub base station to the second mobile station, and thus fails to receive data from the main base station, it transmits a retransmission request NACK to the main base station (303). It should also be understood that the mobile station may directly transmit a retransmission request signal to the sub base station when it transmits the retransmission request NACK to the main base station at 303 (304).

After that, the main base station transmits the retransmission request to the sub base station (305). The sub base station recognizes the received retransmission request signal as a pre-coding matrix index reselection request and then changes the pre-coding matrix index from v₃ to v₄.

Meanwhile, if the first mobile station directly transmits the re-transmission request signal to the sub base station at 304, the procedure does not need to include the step of 305 and the sub base station can recognize the retransmission request signal, directly received from the first mobile station, as a pre-coding matrix index reselection request. Although v₄ may be a pre-coding matrix index that causes the performance reduction between the sub base station and the second mobile station, compared with the pre-coding matrix index v₃ that was selected at the initial transmission, communication between the main base station and the first mobile station can be successfully performed.

After that, the main base station re-transmits data to the first mobile station using the pre-coding matrix index v₁ (306). In that case, the sub base station transmits data to the second mobile station using a pre-coding matrix index v₄ (307).

FIG. 4 is a view illustrating a configuration of a base station cooperation system for performing retransmission according to a second embodiment of the present invention. FIG. 5 is a view illustrating a concept of a method for performing retransmission in a base station cooperation system according to a second embodiment of the present invention.

Referring to FIGS. 4 and 5, if resources are physically divided, based on a unit of frequency/time, according to the concept of fractional frequency reuse (FFR), and a mobile station requests a retransmission from the main base station, the sub base station must allocate a corresponding resource to users within cells except for the boundary area between cells (which is called inter-cell user selection).

As shown in FIG. 5, base stations BS_{A} and BS_{B} each transmit data to mobile stations 403 and 404 in a boundary area between cells at the first transmission. When the base station BS_{A} intends to retransmit data to the mobile station 403 in the boundary area, the base station BS_{B} changes its transmission target mobile station from the mobile station 404 in the boundary area to a mobile station 405 within a cell in order to reduce interference with transmission of the base station BS_{A}.

Alternatively, retransmission may be performed in such a way the main base station requests a transmission interruption from the sub base station, which is called a silent request. The silent request includes a hard silent request that requests transmission interruption from the sub base station and a soft silent request that reduces transmission power of the sub base station. If the sub base station and the main base station share data that will be transmitted to one mobile station, retransmission can be performed in such a way that the data is transmitted to both the base stations, which is called macro diversity. Although this retransmission may reduce the frequency efficiency, it can be simply achieved and has the greatest probability of success. Since this method distinguishes mobile stations according to whether they are located in a cell or in a boundary area and then allocates resources thereto, it may cause a reduction in scheduling efficiency. Therefore, it is appropriate to use the method only in retransmission rather than the first transmission.

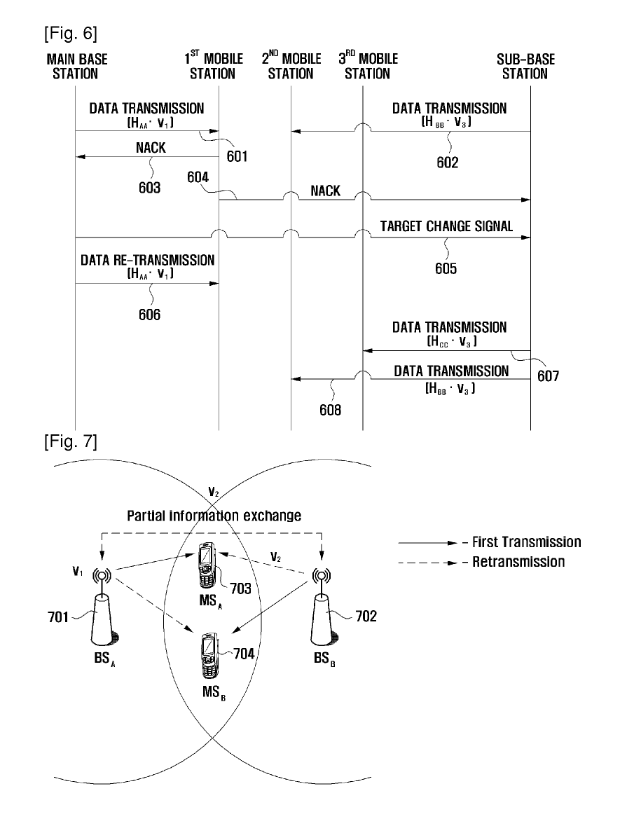

FIG. 6 is a signal flow chart that describes a method for performing retransmission in a base station cooperation system according to a second embodiment of the present invention.

Referring to FIG. 6, the main base station transmits data to the first mobile station via a channel H_{AA} (601). In an embodiment of the present invention, it is assumed that transmission is performed using a pre-coding matrix index v₁, and the sub base station is restricted to use a pre-coding matrix index v₂ by the pre-coding matrix index restriction technique.

The sub base station transmits data to the second mobile station via a channel H_{BB} at the time the main base station performs the data transmission (602). At 602, the sub base station performs the data transmission using a pre-coding matrix index v₃. When the first mobile station recognizes its received signal as an interference signal, interfering with a signal transmitted from the sub base station to the second mobile station, and thus fails to receive data from the main base station, it transmits a retransmission request NACK to the main base station (603). It should also be understood that the mobile station may directly transmit a retransmission request signal to the sub base station when it transmits the retransmission request NACK to the main base station at 603 (604).

After that, the main base station transmits the retransmission request to the sub base station (605). The sub base station recognizes the received retransmission request signal as a transmission target change request and then changes the transmission target mobile station from the second mobile station in a boundary area between cells to a third mobile station within a cell.

Meanwhile, if the first mobile station directly transmits the re-transmission request signal to the sub base station at 604, the procedure does not require the step of 605 and the sub base station can recognize the retransmission request signal, directly received from the first mobile station, as a transmission target change request. Although data transmission to the second mobile station is performed at the next time slot, communication between the sub base station and the third mobile station hardly interferes with communication between the main base station and the first mobile station, so that the main base station can successfully conduct retransmission.

After that, the main base station re-transmits data to the first mobile station using the pre-coding matrix index v₁ (606). In that case, the sub base station transmits data to the third mobile station using a pre-coding matrix index v₃ (607). After completing data retransmission, the sub base station transmits data to the second mobile station (608).

FIG. 7 is a view illustrating a configuration of a base station cooperation system for performing retransmission according to a third embodiment of the present invention.

Referring to FIG. 7, it is assumed that an environment where data among base stations is shared has been established. A data sharing environment refers to an environment where gateways related to base stations transmit duplicated data to base stations.

It is assumed that a mobile station, located in a boundary area between cells in a base station cooperation system, has long term SNRs of links between each of the base stations and the mobile station (BS_{A} and MS_{A}; BS_{B} and MS_{A}), where the long term SNRs are similar to each other. In an embodiment of the present invention, a base station BS_{B} adjacent to base station BSA recognizes information regarding a retransmission request that the mobile station MS_{A} transmits to the base station BS_{A}. When the mobile station MS_{A} transmits a retransmission request to BS_{A} while BS_{A} is transmitting data to the MSA, it receives data from the base station BSB through retransmission that differs from its first transmission. That is, in retransmission, the mobile station receives data from the main base station and the sub base station by exchanging the main base station and the sub base station.

When the BS_{A} transmits a signal to the MS_{A}, the MS_{A} determines a pre-coding matrix index whose effective channel gain is the largest, as an MS_{A} most favorable pre-coding matrix index, from a code book. Similarly, when the BS_{B} transmits a signal to the MS_{A}, the MS_{A} determines a pre-coding matrix index whose effective channel gain is the largest, as the MS_{A} with the least favorable pre-coding matrix index. If BS_{B} transmits a signal to MS_{B} using an MS_{A} least favorable pre-coding matrix index, the signal may be recognized as an interference signal in the MS_{A}. The BS_{A} transmits the MS_{A} most favorable pre-coding matrix index and MS_{A} least favorable pre-coding matrix index to the BS_{A} via a path, such as a backhaul, etc., so that the BS_{A} and BS_{A} can both recognize them.

The BS_{B} recognizes the MS_{A} least favorable pre-coding matrix index as an optimal pre-coding matrix index to transmit a signal to the MS_{A}. Therefore, the MS_{A} receives data from the BS_{B}, instead of the BS_{A}, through retransmission, using the MS_{A} least favorable pre-coding matrix index as a retransmission pre-coding matrix index.

Similar to the operation of the MS_{A}, the embodiment can be modified with respect to the mobile station MS_{B}. That is, when an MS_{B} least favorable pre-coding matrix index is transmitted to the base station BS_{A}, adjacent to the base station BS_{B}, the BS_{A} uses it as a pre-coding matrix index. In an embodiment of the present invention, since additional base station diversity can be acquired, the system can exert a better performance in retransmission.

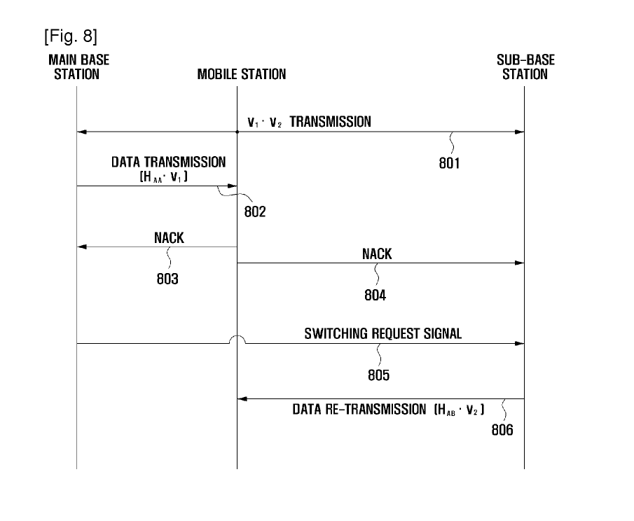

FIG. 8 is a signal flow chart that describes a method for performing retransmission in a base station cooperation system according to a third embodiment of the present invention.

Referring to FIG. 8, a mobile station belonging to the main base station determines a most favorable pre-coding matrix index v₁ and a least favorable pre-coding matrix index v₂, and transmits them to the main base station and also transmits them to the sub base station via a backhaul, etc., for example, (801). Alternatively, the mobile station belonging to the main base station can simultaneously transmit the indexes v₁ and v₂ to the main base station and the sub base station.

After that, the main base station transmits data to the mobile station via a channel H_{AA} (802). It is assumed that the data transmission is performed using the most favorable pre-coding matrix index v₁. If the mobile station detects an error from the signal transmitted from the main base station, it transmits a retransmission request signal NACK to the main base station (803). The embodiment of the present invention may further be implemented in such a way that the mobile station directly transmits a retransmission request signal to the sub base station when it transmits the retransmission request to the main base station (804).

Next, the main base station transmits the retransmission request to the sub base station (805). The sub base station recognizes the received retransmission request signal as a switching request signal and re-transmits data to the mobile station via a channel HAB using a least favorable pre-coding matrix index v₂ (806).

Meanwhile, if the mobile station directly transmits a retransmission request signal to the sub base station, the embodiment of the present invention does not need the step of 805, so the sub base station recognizes the retransmission request signal transmitted from the mobile station as a switching request signal.

Similarly, although it is not explained in detail, it will be appreciated that a mobile station belonging to the sub base station may be operated in the same manner as the mobile station belonging to the main base station.

As described above, the method and system for performing retransmission in a pre-coding matrix index based base station cooperation system, according to the present invention, can allow only a small amount of information to be exchanged among base stations in a base station cooperation system, thereby effectively reducing inter-cell interference and increasing the probability of successfully receiving retransmitted data.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

1. A method for performing a retransmission request in a mobile station in a base station cooperation system, the method comprising:
receiving data from a main base station;
transmitting a retransmission request of the received data; and
receiving the data from the main base station in response to the retransmission request,
wherein a sub base station performing cooperation communication with the main base station receives the retransmission request from the mobile station and changes the format of transmission with respect to mobile stations communicating with the sub base station.

2. The method of claim 1, wherein the sub base station receives the retransmission request from the main base station or the mobile station.

3. The method of claim 1, wherein the format of transmission is a pre-coding matrix index.

4. The method of claim 3, wherein transmitting a retransmission request is requesting to change the pre-coding matrix index, with respect to mobile stations communicating with the sub base station.

5. The method of claim 1, wherein transmitting a retransmission request is requesting to change a mobile station to which the sub base station will transmit data.

6. A mobile station that requests retransmission in a base station cooperation system, comprising a controller for receiving data from a main base station, transmitting a retransmission request of the received data, and receiving the data from the main base station in response to the retransmission request,
wherein a sub base station performing cooperation communication with the main base station receives the retransmission request from the mobile station and changes the format of transmission with respect to mobile stations communicating with the sub base station.

7. The mobile station of claim 6, wherein the controller transmits the retransmission request to the main base station or the sub base station.

8. The mobile station of claim 6, wherein the format of transmission is a pre-coding matrix index.

9. The mobile station of claim 6, wherein the controller controls transmission of the retransmission request to change the pre-coding matrix index, with respect to mobile stations communicating with the sub base station.

10. The mobile station of claim 6, wherein the controller controls transmission of the retransmission request to change a mobile station to which the sub base station will transmit data.

11. A method for transmitting data in a sub base station performing cooperation communication with a main base station in a base station cooperation system, the method comprising:
receiving a retransmission request for data from the main base station;
changing, if the retransmission request is received, the format of transmission with respect to mobile stations within a coverage of the sub base station; and
transmitting the data to the mobile station according to the changed format of transmission.

12. The method of claim 11, wherein receiving a retransmission request is receiving a retransmission request from the main base station or a mobile station communicating with the main base station.

13. The method of claim 11, wherein the format of transmission is a pre-coding matrix index.

14. The method of claim 13, wherein changing the format of transmission is changing the pre-coding matrix index, with respect to mobile stations communicating with the sub base station.

15. The method of claim 11, wherein changing the format of transmission is changing a mobile station to which the sub base station will transmit data.

16. A base station system where a sub base station performs cooperation communication with a main base station in a base station cooperation system and performs transmission of data, the base station system comprising:
a controller for receiving a retransmission request for data transmitted from the main base station, changing the format of transmission with respect to mobile stations within a coverage of the sub base station, and transmitting the data to the mobile station according to the changed format of transmission.

17. The base station system of claim 16, wherein the retransmission request is transmitted from the main base station or a mobile station communicating with the main base station.

18. The base station system of claim 16, wherein the format of transmission is a pre-coding matrix index.

19. The base station system of claim 18, wherein, if the format of transmission is changed, the controller changes the pre-coding matrix index, with respect to mobile stations communicating with the sub base station.

20. The base station system of claim 16, wherein, if the format of transmission is changed, the controller changes a mobile station to which the sub base station will transmit data.
